(19) United States
(12) Patent Application Publication
(10) Pub. No.: US 2008/0286587 A1
(43) Pub. Date: Nov. 20, 2008

(54) Apparatus Having Electric Circuitry and Method of Making Same

(75) Inventors: Joachim Walter Ahner, Pittsburgh, PA (US); Florin Zavaliche, Pittsburgh, PA (US)

Correspondence Address: PIETRAGALLO GORDON ALFANO BOSICK & RASPANTI, LLP, ONE OXFORD CENTRE, 38TH FLOOR, 301 GRANT STREET, PITTSBURGH, PA, 15219-6404, US

(73) Assignee: Seagate Technology LLC, Scotts Valley, CA (US)

(21) Appl. No.: 11/749,368

(22) Filed: May 16, 2007

(51) Int. Cl. B32B 15/04; B05D 5/12; B32B 9/04

(52) U.S. Cl. 428/469; 427/96.1; 428/411.1

(57) ABSTRACT

An apparatus includes a first crystalline material layer, a second crystalline material layer positioned adjacent to the first crystalline material layer to form an electron gas, a first interface, and a first ferroelectric layer having ferroelectric domains that apply an electric field to portions of the first interface. A method of making the apparatus is also provided.

### FIELD OF THE INVENTION

The invention relates generally to electronic devices and more particularly to such devices having electron gas conductors and methods of making such devices.

### BACKGROUND OF THE INVENTION

Integrated circuits include a plurality of electronic devices including transistors, diodes, resistors, capacitors, etc. These devices can be fabricated in a substrate and connected to each other using conductors that are also fabricated in the substrate. It is generally desirable to reduce the size of integrated circuits to allow for use in smaller packages, as well as to reduce power consumption and improve high frequency operation.

### SUMMARY OF THE INVENTION

In a first aspect, the invention provides an apparatus including a first crystalline material layer, a second crystalline material layer positioned adjacent to the first crystalline material layer to form an electron gas at a first interface, and a first ferroelectric layer having ferroelectric domains that apply an electric field to portions of the first interface.

The apparatus can further include a conductive layer. A substrate can be included to support the first and second crystalline material layers and the ferroelectric layer. A buffer layer can be positioned between the substrate and the conductive layer.

The first crystalline material can include a first oxide, and the second crystalline material can include a second oxide. In another example, the first crystalline material can include a first semiconductor, and the second crystalline material can include a second semiconductor.

The apparatus can further include a third crystalline material layer, a fourth crystalline material layer positioned adjacent to the third crystalline material layer to form an electron gas at a second interface, and a second ferroelectric layer having ferroelectric domains that subject portions of the second interface to an electric field.

In another aspect, the invention provides a method, including: providing a medium including a first crystalline material layer, a second crystalline material layer positioned adjacent to the first crystalline material layer to form an electron gas at a first interface, and a first ferroelectric layer. Then the medium can be subjected to an electric field to create polarized ferroelectric domains in the first ferroelectric layer that apply an electric field to portions of the first interface.

### BRIEF DESCRIPTION OF THE DRAWINGS

FIG. 1 is a schematic representation of a medium constructed in accordance with an aspect of the invention.

FIG. 2 is a schematic representation of a medium constructed in accordance with another aspect of the invention.

FIG. 3 is a schematic representation of a medium constructed in accordance with another aspect of the invention.

FIG. 4 is a schematic representation of a medium constructed in accordance with another aspect of the invention.

FIG. 5 is a schematic representation of an apparatus for producing electrically conductive elements in the mediums of FIGS. 1-4.

FIG. 6 is a schematic representation of another apparatus for producing electrically conductive elements in the mediums of FIGS. 1-4.

FIG. 7 is a plan view of a diode that can be formed within the medium.

FIG. 8 is a plan view of a transistor that can be formed within the medium.

FIG. 9 is a plan view of a resistor that can be formed within the medium.

FIG. 10 is a side view of a medium including circuitry constructed in accordance with an aspect of the invention.

### DETAILED DESCRIPTION OF THE INVENTION

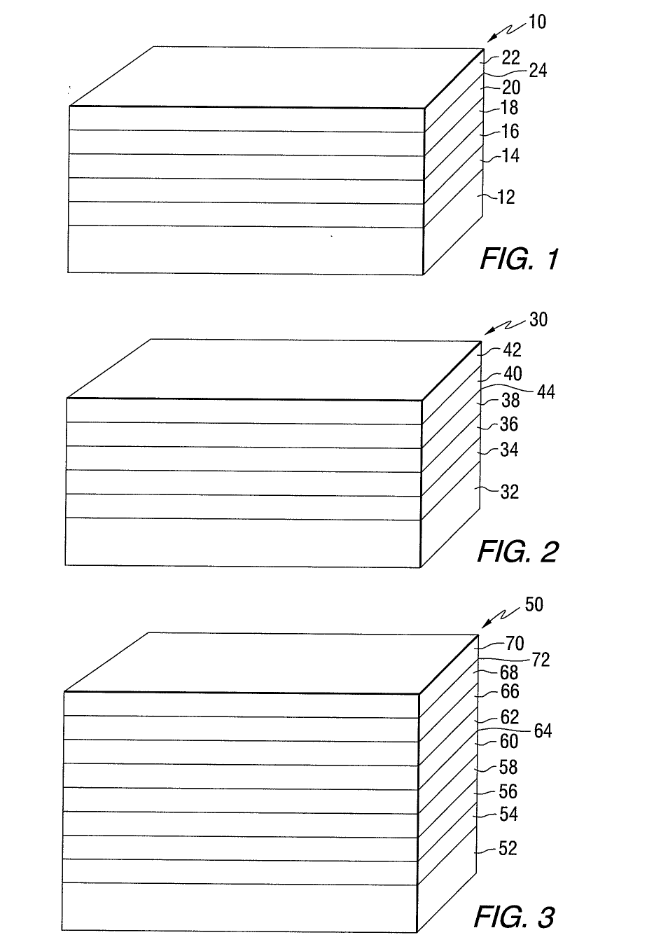

Referring to the drawings, FIG. 1 is a schematic representation of a medium 10 constructed in accordance with an aspect of the invention. In this example, medium 10 is a thin film structure having a plurality of layers or films including a substrate 12, a buffer layer 14, an electrically conductive layer 16, a ferroelectric layer 18, a layer of a first crystalline material 20, and a layer of a second crystalline material 22. The substrate can be for example silicon. The buffer layer 14 can be for example strontium titanate (SrTiO₃), referred to as STO, dysprosium scandate (DyScO₃), referred to as DSO, or gadolinium scandate (GdScO₃), referred to as GSO. The electrically conductive layer 16 can be for example strontium ruthanate (SrRrO₃), referred to as SRO, or LaSrCoO₃, referred to as LSCO. The ferroelectric layer 18 can be for example lead zirconium titanate, (Pb(Zr,Ti)O₃), referred to as PZT, BiFeO₃, referred to as BFO, barium titanate (BaTiO₃), referred to as BTO, or strained and therefore ferroelectric strontium titanate (SrTiO₃), referred to as strained STO. The first and second crystalline materials can be, for example an oxide such as strontium titanate (SrTiO₃), referred to as STO, lead vanadate (PbVO₃), referred to as PVO, lanthanum aluminate (LaAlO₃), referred to as LAO, lanthanum manganite (LaMnO₃), referred to as LMO, LaCaMnO₃, referred to as LCMO, LaSrMnO₃, referred to as LSMO, or a semiconductor such as a doped silicon, germanium, or GaAs. Different materials are used for adjacent crystalline material layers. An interface 24 is formed between the heterostructure layers.

In a layered structure having layers of crystalline materials, polarity discontinuities at the interface between different crystalline materials, i.e. heterointerfaces, can lead to a localized atomic and electronic structure. This localized atomic and electronic structure can produce quasi-two-dimensional electron gases (q2-DEG) at the interfaces. The crystalline materials can be insulating oxides or semiconductors having doping layers that are spatially separated from the high-mobility quasi-two-dimensional electron gas. The q2-DEG contains electrons that are free to move in the in-plane direction, i.e., along the heterointerfaces. The q2-DEG forms spontaneously and the conductance of the q2-DEG can be controlled by the magnitude and polarity of an electric field introduced across the interface.

Due to the physical properties of the crystalline materials, an electron gas forms at the interface 24. The electron gas can include high-mobility electrons such that it approaches the conductivity of a metal. The lateral location of the electron gas can be controlled by subjecting the interface to an electric field. Stable ferroelectric domains can be created in the ferroelectric layer. These ferroelectric domains generate an electric field at the interface. While the layers of FIG. 1 are shown to be positioned immediately adjacent to each other, these layers could be separated by additional buffer layers or seed layers. In addition, the order of the layers can be changed.

FIG. 2 is a schematic representation of a medium 30 constructed in accordance with another aspect of the invention. In this example, medium 30 is a thin film structure having a plurality of layers or films including a substrate 32, which can be for example silicon, a buffer layer 34, which can be for example STO, DSO, or GSO, an electrically conductive layer 36, which can be for example SRO, or LSCO, a layer 38 of a first crystalline material, a layer 40 of a second crystalline material, and a ferroelectric layer 42, which can be for example PZT, BFO, BTO, or strained STO. The first and second crystalline material layers can be, for example STO, PVO, LAO, LMO, LCMO, LSMO, or a semiconductor such as a doped silicon, germanium, or GaAs. Different materials are used for adjacent crystalline material layers. An interface 44 is formed between the heterostructure layers.

Due to the physical properties of the crystalline materials, an electron gas forms at the interface 44. The electron gas can include high-mobility electrons such that it approaches the conductivity of a metal. The location of the electron gas can be controlled by subjecting the interface to an electric field. Stable ferroelectric domains can be created in the ferroelectric layer. These ferroelectric domains generate an electric field at the interface. While the layers of FIG. 2 are shown to be positioned immediately adjacent to each other, it will be understood by those skilled in the art that these layers could be separated by additional buffer layers or seed layers. In addition, the order of the layers can be changed.

FIG. 3 is a schematic representation of a medium 50 constructed in accordance with another aspect of the invention. In this example, medium 50 is a thin film structure having a plurality of layers or films including a substrate 52, which can be for example silicon, a buffer layer 54, which can be for example STO, DSO, or GSO, an electrically conductive layer 56, which can be for example SRO, or LSCO, a first ferroelectric layer 58, which can be for example PZT, BFO, BTO, or strained STO, a layer 60 of a first crystalline material, and a layer 62 of a second crystalline material. The first and second crystalline materials can be, for example STO, PVO, LAO, LMO, LCMO, LSMO, or a semiconductor such as a doped silicon, germanium, or GaAs. Different materials are used for adjacent crystalline material layers. An interface 64 is formed between the first and second layers. The medium of FIG. 3 further includes a second ferroelectric layer 66, which can be for example PZT, BFO, BTO, or strained STO, a layer 68 of a third crystalline material, and a layer 70 of a fourth crystalline material. The third and fourth crystalline materials can be, for example STO, PVO, LAO, LMO, LCMO, LSMO, or a semiconductor such as a doped silicon, germanium, or GaAs. Different materials are used for adjacent crystalline material layers. An interface 72 is formed between the third and fourth oxide layers.

Due to the physical properties of the crystalline materials, an electron gas forms at the interfaces 64 and 72. The first and second ferroelectric layers can have different properties, such that by changing the magnitude of the applied electric field, the location and depth of the interface, at which the electron gas forms, can be controlled.

The electron gas can include high-mobility electrons such that it approaches the conductivity of a metal. The location of the electron gas can be controlled by subjecting the interface to an electric field. Stable electric domains can be created in the ferroelectric layers. These ferroelectric domains generate an electric field at the interface. While the layers of FIG. 3 are shown to be positioned immediately adjacent to each other, it will be understood by those skilled in the art that these layers could be separated by additional buffer layers or seed layers. In addition, the order of the layers can be changed.

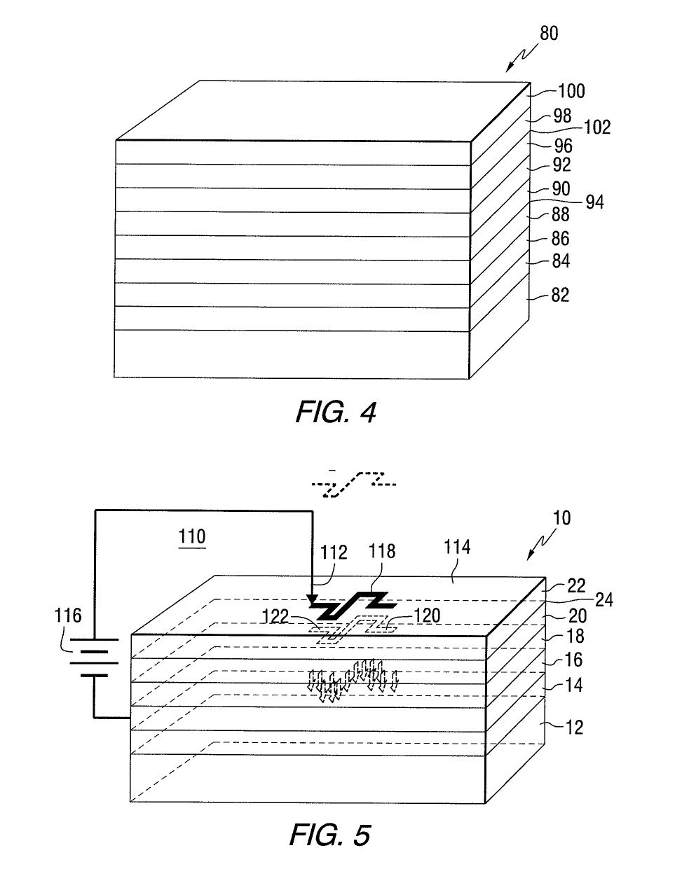

FIG. 4 is a schematic representation of a medium 80 constructed in accordance with another aspect of the invention. In this example, medium 80 is a thin film structure having a plurality of layers or films including a substrate 82, which can be for example silicon, a buffer layer 84, which can be for example STO, DSO, or GSO, an electrically conductive layer 86, which can be for example SRO, or LSCO, a layer 88 of a first crystalline material, a layer 90 of a second crystalline material, and a first ferroelectric layer 92, which can be for example PZT, BFO, BTO, or strained STO. The first and second crystalline materials can be, for example STO, PVO, LAO, LMO, LCMO, LSMO, or a semiconductor such as a doped silicon, germanium, or GaAs. Different materials are used for adjacent crystalline material layers. An interface 94 is formed between the first and second layers of crystalline material. The medium of FIG. 4 further includes a layer 96 of a third crystalline material, a layer 98 of a fourth crystalline material, and a second ferroelectric layer 100, which can be for example PZT, BFO, BTO, or strained STO. The third and fourth crystalline material layers can be, for example STO, PVO, LAO, LMO, LCMO, LSMO, or a semiconductor such as a doped silicon, germanium, or GaAs. The crystalline material layers can be heterostructures that can be epitaxially grown. Different materials are used for adjacent crystalline material layers. An interface 102 is formed between the third and fourth crystalline material layers.

Due to the physical properties of the crystalline materials, an electron gas forms at the interfaces 94 and 102. The first and second ferroelectric layers can have different properties, such that by changing the magnitude of the applied electric field, the location and depth of the interface, at which the electron gas forms, can be controlled.

The electron gas can include high-mobility electrons such that it approaches the conductivity of a metal. The location of the electron gas can be controlled by subjecting the interface to an electric field. Stable electric domains can be created in the ferroelectric layer. These ferroelectric domains generate an electric field at the interface. While the layers of FIG. 4 are shown to be positioned immediately adjacent to each other, it will be understood by those skilled in the art that these layers could be separated by additional buffer layers or seed layers. In addition, the order of the layers can be changed.

In one aspect the invention provides a method of producing electric circuitry comprising the steps of providing a medium including a first crystalline material layer, a second crystalline material layer positioned adjacent to the first crystalline material layer to form a first interface, and a first ferroelectric layer. Then the medium can be subjected to an electric field to create polarized ferroelectric domains in the ferroelectric layer that subject portions of the first interface to an electric field. The ferroelectric domains in the ferroelectric material can be polarized to maintain an electron gas along the first interface. The domains apply an electric field to the interface to maintain the electron gas in a pattern corresponding to the locations of the domains.

In the examples of FIGS. 1-4, the thickness of the first and second crystalline material layers can range from about 1 nm to about 5 nm. The thickness of the ferroelectric layers can range from about 5 mm to about 50 nm. The thickness of the electrically conductive layers can range from about 30 nm to about 100 nm. The thickness of the buffer layer can range from about 2 nm to about 50 nm. The thickness of the two crystalline material layers need not be the same.

FIG. 5 is a schematic representation of an apparatus 110 for producing electrically conductive elements in the mediums of FIGS. 1-4. In the example shown in FIG. 5, the medium of FIG. 1 is illustrated. The apparatus of FIG. 5 includes a transducer 112, in the form of an electrode that is positioned adjacent to a surface 114 of oxide layer 22. Such positioning can be implemented using a known electrode positioning device, such as might be found in an atomic force microscope. A voltage source 116 is electrically connected between the conductive layer 16 and the transducer 112. The voltage difference between the transducer and the conductive layer subjects the medium 10 to an electric field between the transducer and the conductive layer. As the transducer is moved along a path 118 with respect to the medium, electron gas 120 is formed at the interface between the insulating oxide layers, and ferroelectric domains are formed in the ferroelectric layer. In FIG. 5, these domains are shown as arrows in the ferroelectric layer 18. The domains persist after the external electric field has been removed. In a ferroelectric material such as PZT, the domains can persist for many years.

When a voltage is applied between the transducer and the conducting layer under the ferroelectric film, the polarization of domains in the ferroelectric film can be switched locally in an up or down oriented polarization state, depending upon the amplitude and polarity of the applied voltage. When scanning the transducer over the medium, any pattern of up or down polarized domain states can be printed in the ferroelectric layer with a precision depending on the scanner accuracy and the size of the transducer electrode at the transducer-to-medium interface, also called the head-to-media interface. Such domain patterns are thermally stable and features down to about 16 nm in size have been demonstrated.

The ferroelectric layer domains provide an electric field pattern, which is used to maintain a conducting quasi-two-dimensional electron gas (q2-DEG) between two insulating dielectric oxide layers. The local confinement of the q2-DEG is defined by the domain pattern written into the ferroelectric layer.

The q2-DEG between dielectric perovskite films can have electron mobilities of up to 10⁴ cm² Vs. Any two-dimensional conducting circuitry with resolution down to about 16 nm can be written into the medium. Since the ferroelectric domain pattern is fully programmable (i.e., can be readily changed) by switching the polarization state, the circuitry is fully programmable (i.e., can be readily changed) and can be rewritten.

The domains in the ferroelectric layer subject the interface to an electric field in the vicinity of the domains. This maintains the electron gas at the interface locations that is subjected to the electric field. Thus as the transducer is scanned, for example along the path 120, ferroelectric domains are created in the ferroelectric layer under the transducer and electron gas is formed along the interface under the path followed by the transducer. The electron gas thus forms an electrical conductor 122 that is embedded in the medium at the interface.

The electric field associated with the ferroelectric domains is responsible for the conductance of the q2-DEG. The electron gas would be closely confined only to areas adjacent to the up or down polarized domains. Field spreading in a lateral direction is minimized, due to the use of very thin films. Also, the anisotropic dielectric permittivity of the ferroelectric films could be chosen or designed to minimize lateral field spreading. The conductance of the q2-DEG can be switched on or off by changing the polarity of the domains in the ferroelectric film. The actual polarity of the field, which switches the q2-DEG on or off depends on the materials of the interface and the location of the ferroelectric film. The whole ferroelectric film would be polarized. The q2-DEG forms only in regions where the polarization is switched in the “active” direction, where the active direction is the direction that maintains the q2-DEG for the particular materials used in the structure.

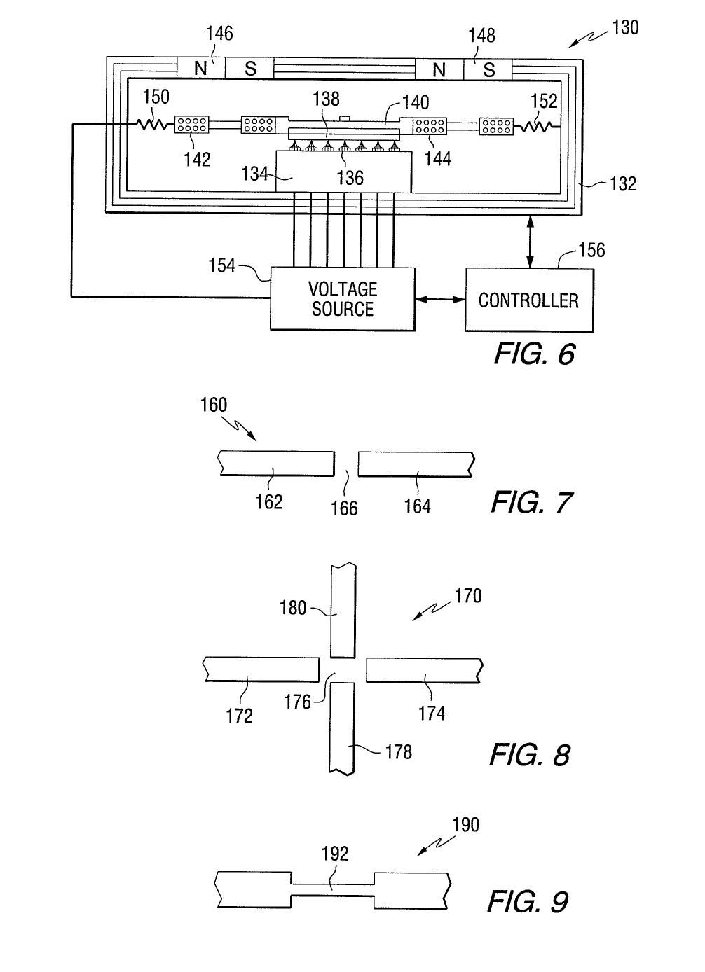

Multiple transducers can be used to form multiple conductive paths in the medium. FIG. 6 is a schematic representation of another apparatus for producing electrically conductive elements in the mediums of FIGS. 1-4. FIG. 6 shows an apparatus 130 that includes actuators and suspension assemblies for providing relative movement between the medium and an array of transducers, which can be electrically conductive tips or probes. The apparatus 130 includes an enclosure 132, also referred to as a case, base, or frame, which contains a substrate 134. An array of transducers 136 is positioned on the substrate. The probes extend upward to make contact with a medium 138. The medium 138 is mounted on a movable member, or sled 140. In this example, relative movement between the medium 138 and the transducers is provided by an electromagnetic actuator that includes coils and magnets. Coils 142 and 144 are mounted on the movable member. Magnets 146 and 148 are mounted in the enclosure near the coils. Springs 150 and 152 form part of a suspension assembly that supports the movable member. The enclosure 132 can be formed of, for example, injection molded plastic. The actuators and suspension assembly shown in FIG. 6 are examples of structures that can provide relative displacement of transducers and a medium, which can contain rewritable circuitry. It will be understood by those skilled in the art that other types of actuators, such as surface drive capacitive actuators, could be used.

A voltage source 154 is electrically connected between a conductive layer in the medium and each of the transducers. The electrical connection to the conductive layer can be made, for example, through the springs, or using a separate conductor. Relative movement of the medium and the transducers is controlled by a controller 156. The controller can be programmed to control the actuators to move the sled in a desired pattern and to apply voltages to particular ones of the transducers at desired times to create the desired domain pattern in the ferroelectric layer of the medium. Sensors can be included to sense the position of the medium and/or the transducers and provide position signals for use by the controller.

While FIG. 6 shows one example of an apparatus that can be used to perform the method of the invention, it will be recognized that other known types of suspensions and actuators can be used to position the components and to provide relative movement between the probes and the medium. This invention is not limited to any particular type of structure for providing relative movement between one or more transducers and a medium, or to any particular type of transducer or probe, or to any particular means for applying voltage to the medium.

The conductive paths formed as described can be used to form various electronic devices in the media such as, for example, transistors, diodes, resistors, capacitors, etc.

FIG. 7 is a plan view of a diode 160 that can be formed within the media. The diode includes first and second electrodes 162 and 164 separated by a gap 166. The electrodes are conductive regions in the media in the form of q2-DEG domains. The gap is filled with an insulating material, which can be one of the oxide materials described above. When a voltage is applied to the electrodes, electrons will tunnel across the gap and provide the diode function.

FIG. 8 is a plan view of a transistor 170 that can be formed within the media. The transistor includes first and second electrodes 172 and 174 separated by a gap 176, and third and fourth electrodes 178 and 180, which are also separated by the gap. Electrodes 172 and 174 can form the source and drain of the transistor, and electrodes 178 and 180 can form the gate. The gap is filled with an insulating material, which can be one of the oxide materials described above.

FIG. 9 is a plan view of a resistor 190 that can be formed within the media. The resistor is formed of an electron gas conductor 192. The width of the conductor can be adjusted to control the resistance. Alternatively, the oxide materials can be doped to control the mobility of the electrons in the electron gas, and thereby control the resistance. Such doping could be uniform within the oxide layer.

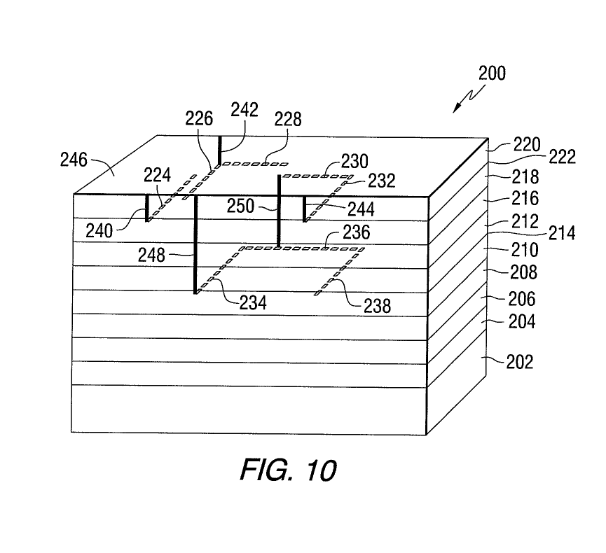

Electrical contact points can be created between the conductors created as described above and the surface of the medium, or between layers of the medium. Such contact points can be created, for example using known lithographic techniques, using ion implantation, or using electrical breakdown of the medium layer. FIG. 10 is an isometric view of a medium 200. In this example, the medium 200 is a thin film structure including a substrate 202, which can be for example silicon, a buffer layer 204, which can be for example STO, DSO, or GSO, an electrically conductive layer 206, which can be for example SRO or LSCO, a first ferroelectric layer 208, which can be for example PZT, BFO, BTO, or strained STO, a layer 210 of a first crystalline material and a layer 212 of a second crystalline material. The first and second crystalline materials can be, for example STO, PVO, LAO, LMO, LCMO, LSMO, or a semiconductor such as a doped silicon, germanium, or GaAs. Different materials are used for adjacent crystalline material layers. An interface 214 is formed between the first and second layers. The medium of FIG. 10 further includes a second ferroelectric layer 216, which can be for example PZT, BFO, BTO, or strained STO, a layer 218 of a third crystalline material and a layer 220 of a fourth crystalline material. The third and fourth crystalline materials can be, for example STO, PVO, LAO, LMO, LCMO, LSMO, or a semiconductor such as a doped silicon, germanium, or GaAs. The crystalline material layers can be heterostructures that can be epitaxially grown. Different materials are used for adjacent crystalline material layers. An interface 222 is formed between the third and fourth oxide layers.

Due to the physical properties of the crystalline materials, an electron gas forms at the interfaces 204 and 222. By applying an electric field as shown in FIG. 5, conductors 224, 226, 228, 230 and 232 have been created along interface 222. Similarly, conductors 234, 236 and 238 have been created along interface 214. These conductors are formed from an electron gas and the electron gas is maintained by ferroelectric domains in the ferroelectric layers. Vertical conductors, or vias, 240, 242 and 244 have been included to electrically connect the conductors along interface 222 to connection points on the surface 246 of layer 220. Another vertical conductor, or via, 248 has been included to electrically connect the conductors along interface 214 to a connection point on the surface 246 of layer 220. Another vertical conductor, or via, 250 has been included to electrically connect the conductor 230 to conductor 236. The various vertical conductors are illustrative of the types of conductors that can be included to electrically connect the electron gas conductors with each other or with external circuits. These vertical conductors can be created using, for example, ion implantation, lithographic techniques, or electrical breakdown. Additional electric circuitry can be formed on the surfaces of the medium using known techniques. The vertical conductors or vias could be formed before the electron gas conductors to avoid erasing that circuitry in the medium.

Permanently conducting vertical wires could be formed by lithography methods, for example by etching holes and filling the holes with metals, by ion implantation through a hard mask, or by using the movable top electrode, or probe, and applying a voltage larger than the breakdown voltage of the films.

Rewritable vertical conductors may be formed by controlled doping and resistively switching the thin films between the transducer electrode and q2-DEG interface. Reversible resistive switching in oxide films, including ferroelectrics typically occurs after doping and applying a voltage pulse to the transducer electrode, with an amplitude larger than the switching voltage for the ferroelectric film, but lower than the breakdown voltage.

In one aspect, the apparatus of this invention comprises a rewritable medium including a stack of thin insulation or semiconducting films, one or more metallic films, and one or more ferroelectric layers. A single transducer or an array of transducers can be scanned over the medium to write circuitries in the media by locally switching the polarizations of domains in the ferroelectric layer.

Although the invention has been described in terms of several examples, it is to be understood that the invention is not limited to the described examples, and that various modifications may be practiced within the scope of the invention defined by the appended claims.

What is claimed is:

1. An apparatus, comprising:
a first crystalline material layer;
a second crystalline material layer positioned adjacent to the first crystalline material layer to form an electron gas at a first interface; and
a first ferroelectric layer having ferroelectric domains that apply an electric field to portions of the first interface.

2. The apparatus of claim 1, further comprising:
a conductive layer; and
a substrate positioned adjacent to the conductive layer.

3. The apparatus of claim 2, wherein the conductive layer comprises one of: SrRrO₃ or LaSrCoO₃.

4. The apparatus of claim 2, further comprising:
a buffer layer between the substrate and the conductive layer.

5. The apparatus of claim 4, wherein the buffer layer comprises one of: SrTiO₃, DyScO₃, or GdNbO₃.

6. The apparatus of claim 1, wherein the first crystalline material comprises a first oxide, and the second crystalline material comprises a second oxide.

7. The apparatus of claim 1, wherein the first crystalline material comprises one of: SrTiO₃, PbVO₃, LaAlO₃, LaMnO₃, LaCaMnO₃, or LaSrMnO₃, and the second crystalline material comprises one of: SrTiO₃, PbVO₃, LaAlO₃, LaMnO₃, LaCaMnO₃, or LaSrMnO₃.

8. The apparatus of claim 1, wherein the first crystalline material comprises a first semiconductor, and the second crystalline material comprises a second semiconductor.

9. The apparatus of claim 1, wherein the first ferroelectric layer comprises one of: Pb(Zr,Ti)O₃, BiFeO₃, BaTiO₃, or strained SrTiO₃.

10. The apparatus of claim 1, wherein the first ferroelectric layer has a thickness in the range of about 5 nm to about 50 nm, the first crystalline material has a thickness in the range of about 1 nm to about 5 nm, and the second crystalline material has a thickness in the range of about 1 nm to about 5 nm.

11. The apparatus of claim 1, further comprising:
a third crystalline material layer;
a fourth crystalline material layer positioned adjacent to the third crystalline material layer to form an electron gas at a second interface; and
a second ferroelectric layer having ferroelectric domains that subject portions of the second interface to an electric field.

12. A method, comprising:
providing a medium including a first crystalline material layer, a second crystalline material layer positioned adjacent to the first crystalline material layer to form an electron gas at a first interface, and a first ferroelectic layer; and
subjecting the medium to an electric field to create polarized ferroelectric domains in the ferroelectric layer that apply an electric field to portions of the first interface.

13. The method of claim 12, wherein the medium further comprises:
a conductive layer; and
a substrate positioned adjacent to the conductive layer.

14. The method of claim 13, wherein the conductive layer comprises one of: SrRrO₃ or LaSrCoO₃.

15. The method of claim 13, wherein the medium further comprises:
a buffer layer between the substrate and the conductive layer.

16. The method of claim 15, wherein the buffer layer comprises one of: SrTiO₃, DyScO₃, or GdScO₃.

17. The method of claim 12, wherein the first crystalline material comprises a first oxide, and the second crystalline material comprises a second oxide.

18. The method of claim 12, wherein the first crystalline material comprises one of: SrTiO₃, PbVO₃, LaAlO₃, LaMnO₃, LaCaMnO₃, or LaSrMnO₃, and the second crystalline material comprises one of: SrTiO₃, PbVO₃, LaAlO₃, LaMnO₃, LaCaMnO₃, or LaSrMnO₃.

19. The method of claim 12, wherein the first crystalline material comprises a first semiconductor, and the second crystalline material comprises a second semiconductor.

20. The method of claim 12, wherein the first ferroelectric layer comprises one of: Pb(Zr,Ti)O₃, BiFeO₃, BaTiO₃, or strained SrTiO₃.

21. The method of claim 12, wherein the first ferroelectric layer has a thickness in the range of about 5 nm to about 50 nm, the first crystalline material has a thickness in the range of about 1 nm to about 5 nm, and the second crystalline material has a thickness in the range of about 1 nm to about 5 nm.

22. The method of claim 12, wherein the medium further comprises:
a third crystalline material layer;
a fourth crystalline material layer positioned adjacent to the third crystalline material layer to form an electron gas at a second interface; and
a second ferroelectric layer having ferroelectric domains that subject portions of the second interface to an electric field.
